(19) United States
(12) Patent Application Publication
(10) Pub. No.: US 2014/0171545 A1
(43) Pub. Date: Jun. 19, 2014

(54) ANTIMICROBIAL FILLERS FOR PLASTICS

(71) Applicant: Contact Marketing Solutions Innovative Technologies, (US)

(72) Inventors: David H. Creasey, Splendora, TX (US); Barry W. Cummins, Butler, KY (US); Todd Becker, Ridgefield, CT (US); Jason H. Creasey, Conroe, TX (US)

(73) Assignee: Contact Marketing Solutions Innovative Technologies, Danbury, CT (US)

(21) Appl. No.: 13/838,505

(22) Filed: Mar. 15, 2013

Related U.S. Application Data
(60) Provisional application No. 61/737,949, filed on Dec. 17, 2012.

(51) Int. Cl. C08K 3/26; C08K 3/30

(52) U.S. Cl. CPC C08K 3/26; C08K 3/30
USPC 523/122; 424/687

(57) ABSTRACT

Enhanced fillers for plastics, their preparation and their use in plastic products imparting antimicrobial properties and improved tensile strength and other physical properties are presented.

### CROSS REFERENCE TO RELATED APPLICATIONS

This application claims benefit to U.S. Provisional Application 61/737,949, filed Dec. 17, 2012, which is incorporated herein by reference.

### FIELD OF THE INVENTION

The invention relates generally to compositions imparting antimicrobial, anti-odor and strengthening properties to plastics and their use in fillers in plastics.

### BACKGROUND OF THE INVENTION

Filler compounds frequently are used in the polymer plastics industry, particularly in thermoplastics, to reduce the expense of polymer use, and to improve the strength, rigidity, heat resistance, and/or molding properties of the plastic product. Inorganic compounds, such as calcium carbonate (CaCO₃), talc (Mg₃Si₄O(OH)₂), wollastonite (CaSiO₃), dolomite (CaMg)(CO₃)₂), gypsum (CaSO₄.2H₂O), kaolinite (Al₂Si₂O₅(OH)₄), aluminum hydroxide (Al(OH)₃), micas, and silica-containing aggregates such as diatomite, perlite, and vermiculite are commonly employed as filler compounds.

Many filler materials, however, support the growth of bacteria and can transmit bacteria to plastic products. Therefore, a method and composition to deter bacterial growth in fillers and to impart antibacterial properties to plastic products optionally containing fillers would be useful. If such a method and composition also were to improve the physical properties of the plastic, especially to improve the tensile strength of the plastic and thereby permit formation of stronger plastic products or permit formulation of plastic products having such physical properties equivalent or improved over plastics not employing the method and composition, but containing lower quantities of olefins, acrylates, urethanes or any other monomer components known in the art to polymerize to form a plastic, then both economic and environmental advantages, including reduced use of petroleum products, could be achieved. Accordingly, a method and composition to improve the physical properties of a plastic independent of pretreatment or presence of the filler would be advantageous.

Ong et al. (U.S. Pat. No. 6,979,455) disclose an antimicrobial concentrate manufactured from a carrier, an antimicrobial agent and other optional components, wherein the carrier comprises a modified ethylene polymer. The specification discloses that polar functional groups of antimicrobials are incompatible with nonpolar olefins and other monomer components of most plastics. The specification further discloses that incorporating a modified ethylene polymer into a polymer matrix would render the matrix compatible with the antimicrobial and improve its dispersal uniformity, reduce chalking, and reduce taste and odor within the matrix while retaining antimicrobial activity. Although likely an improvement over the prior art as to taste, odor, and chalking, the requirement for use of a modified ethylene polymer increases costs and is not disclosed to improve the physical characteristics of the plastic.

Neigel et al. (US Publication 2011/0233810) disclose a plastic composition in which an antimicrobial compound uniformly is dispersed in the plastic. The disclosure is directed to antimicrobial silanol quaternary ammonium compounds and their salts (SQACs) having a hydroxyl or hydrolyzable silane group capable of undergoing a condensation polymerization reaction to form a homo or copolymer, and/or forming a covalent bond with the plastic and/or other components in the plastic composition. The antimicrobial composition is disclosed to have improved chemical properties, including tensile strength. The specification sets forth in paragraph [0009] that a number of properties are required for suitable performance of an antimicrobial compounded in plastics: (1) antimicrobial effectiveness, (2) uniform distribution, (3) chemical stability, durability (non-leaching), (4) lack of negative effects on physical properties of the plastic, and (5) low human and environmental toxicity. The instant composition is not an SQAC and not only exhibits antimicrobial properties, but also improves physical properties of plastics, including tensile strength, rigidity, and the like, and imparts odor-inhibiting properties to the plastic containing the claimed composition.

### SUMMARY OF THE INVENTION

Antimicrobial and/or strengthening and/or anti-odor compositions and their use in plastics and/or combined with fillers for plastics, and a method for making the antimicrobial and/or strengthening compositions for plastics and/or fillers are described. The method comprises creating an aqueous composition from components such as ammonium sulfate, potassium sulfate, magnesium sulfate, zinc sulfate and/or sodium sulfate, a metal salt such as silver sulfate and/or copper sulfate, and a strong acid, optionally combined with a cyclodextrin to reduce odors, mixing with plastic resin directly or mixing with a filler material and forming the combination into a shape and size suitable for a plastic filler application.

### BRIEF DESCRIPTION OF THE SEVERAL VIEWS OF THE DRAWINGS

FIG. 1. Tensile strength vs. CaCO₃ loading at four composition concentrations in linear low-density polyethylene (LLDPE).

FIG. 2. Tensile strength vs. composition concentration at four loadings of CaCO₃ filler in LLDPE.

FIG. 3. Tensile strength vs. composition concentration at four loadings of CaCO₃ filler in LLDPE.

FIG. 4: Tensile strength vs. CaCO₃ loading at four composition concentrations in LLDPE.

FIG. 5: Young's tensile modulus vs. composition concentration at four loadings of CaCO₃ filler in LLDPE.

FIG. 6: Young's tensile modulus vs. CaCO₃ loading at four composition concentrations in LLDPE.

### DETAILED DESCRIPTION OF THE INVENTION

An acidic composition of matter is disclosed in U.S. Pat. Nos. 5,989,595 and RE 41,109 to Cummins, which are incorporated herein by reference in their entirety. As described below, it now has been found that this composition, combined with a plastic resin as part of a compounding or master batch process as an additive, or combined with a plastic filler to produce an enhanced filler, is useful for controlling bacterial growth in and around plastics and for increasing the tensile strength, durability and other physical properties of plastics. A cyclodextrin modification of this composition is useful for controlling odors of materials placed in contact or nearby plastics containing the composition.

A composition for treating plastic resin or plastic filler compounds before or after mixing with plastic resin is shown to provide plastics with these antimicrobial, physical and other advantageous properties. The composition is prepared as a stock solution and is diluted in an aqueous solution for use at a concentration of 0.075% to 0.3%, preferably 0.1 to 0.15%. The stock solution contains sodium sulfate and/or ammonium sulfate, preferably about 3-4% total weight to weight; silver sulfate, preferably about 0.2-0.4% weight to weight; copper sulfate, preferably about 0.1-1% weight to weight; and sulfuric acid, preferably about 10-15% weight to weight; mixed in water. The pH of the stock solution ranges from about 5.0 to about 6.5. The solution is heat stable from about 258° F. to about 320° F. Degradation at high temperatures is slower than with untreated acids, and, at 450° F., about 60% of the acid remains undegraded. The antimicrobial solution also is light stable.

A selected filler material is prepared according to standard protocols for the type of filler. For example, protocols for one embodiment using a calcium carbonate filler is described in Example 2. In this exemplary embodiment, the composition is added to the filler material prior to blending to form an extrudable or moldable substance, preferably in the form of treated pellets. The average particle size of the filler particles ranges from about 0.1 to 50 μm. The composition alternatively may be added into a master batch comprising filler material and polymer resin.

The composition is aqueous and comprises, as a first component, an acid selected from sulfuric acid, phosphoric acid, fumaric acid, acetic acid, nitric acid or hydrochloric acid. The acid preferably is of high purity, for example, between about 89% to about 99.9% purity. A second component is selected from at least one of an ammonium compound, sodium sulfate, potassium sulfate, zinc sulfate and/or magnesium sulfate. The ammonium compound is preferably anhydrous ammonia, ammonia monohydrate, ammonium sulfate, or urea ammonium nitrate (UAN), but is most preferably ammonium sulfate. The composition further comprises at least one metal ion. The metal ion preferably is selected from copper, silver, zinc, magnesium, manganese, nickel, and iron. Other noble metals and titanium could also be used. The metal ion is generally provided as a metal sulfate.

In one embodiment, the second component of the composition is prepared by first heating water of any type, preferably distilled or deionized water, to between 65° F. and 210° F., preferably 70° F. to 170° F. The ammonium compound is added to the heated water to give a concentration of about 5% to about 35% and the solution is mixed to dissolve the ammonium compound. In other embodiments, sodium sulfate, potassium sulfate, or magnesium sulfate is combined with the water instead of an ammonium compound. In another embodiment, the second component is added to water that has not been heated.

The resulting solution of the second component is then added simultaneously with the acid to a pressure vessel. The acid is added to comprise about 10% to about 60% of the final concentrated solution, preferably about 15% to 40%. In one embodiment, the reaction is allowed to proceed under pressure of atmospheric to about 80 psi above atmospheric pressure, preferably between atmospheric and about 15 psi above atmospheric pressure, while a DC current is passed through the mixture at a current of at least one amp. In other embodiments the application of pressure above atmospheric and/or DC current is omitted.

The time and temperature of the reaction will vary based on the amount of reactants, size of reactor and reactivity of selected reactants. The temperature of the mixture is maintained in a range between about 125° F. and about 1000° F. during the reaction. The reaction time varies between about 30 minutes and about 6 hours, preferably between 1 and 3 hours. A cooling jacket may be required to control the temperature of the reaction. After the reaction has proceeded to completion, the mixture is allowed to cool or can be cooled by any appropriate means. In one embodiment, the original solution of the second component is added at about 10% to about 15% of the total weight of the final, cooled mixture. In another embodiment, this step is omitted.

The pH of the final, concentrated solution is zero or less. The concentrated solution is diluted with water, preferably distilled or deionized water, and additional components are added.

One or more metal sulfates are added to the solution in a concentration range of 0.5% to 30%. Mixing of the components can be performed by any appropriate means. One or more other components can be added to the diluted solution to enhance its performance in controlling odors associated with the plastic or the environment in which the plastic is placed. For example, microporous aluminosilicate minerals may be added to the solution at 0.5 g/L to 50 g/L, preferably 5.0 g/I to 25 g/L. The acid composition is diluted in a range of from about 1:10 to about 1:5000.

A polyol, such as propylene glycol, glycerin, guar gum, etc., can be added at 2 to 80 ml/L. Sodium acid pyrophosphate (SAPP) can be added in a concentration range of about 1% to about 8%, preferably about 3% to about 5%. Phosphoric acid, preferably about 75% grade, can be added in a concentration range of 2 to 20 ml/L preferably 5 to 15 ml/L. A cyclodextrin, preferably alpha, beta, or gamma cyclodextrin, most preferably beta cyclodextrin, can be added to a final concentration of 2 to 20 g/L, preferably 6 to 12 g/L, to impart odor reducing properties to a plastic, with or without the presence of a filler. Mixing of the components can be performed by any appropriate means.

Preservatives, such as sodium benzoate and potassium benzoate, may also be added to the composition to deter fungal growth. Sodium or potassium benzoate may be added in a concentration range of 0.05% to 10%.

The term “plastic” or “plastics”, as used herein, denotes a synthetic, thermoplastic or thermosetting polymer and/or resin, or a synthetic/natural composite thereof. The composition or the treated filler pellets may be utilized in the preparation of polymer plastics according to industry custom and are appropriate for use with plastic polymers such as polyethylene, polystyrene, polypropylene, polycarbonate, polyolefin, polyvinyl chloride, polyurethane, acrylates, methacrylates, polyamides, vinyl polymers, polyalkylene oxide, copolymers, grafts, and blends thereof, as well as latex (natural rubber) and styrene-butadiene rubber (synthetic rubber).

The antimicrobial composition deters growth of bacteria on the filler material and, unexpectedly, imparts antibacterial properties and increased tensile strength and other physical improvements to plastics.

The composition or the treated filler material may be used in any plastics application where filler is used, for example injection molded products, compression molded products, blown products, cold-formed products, extrusion coatings, films, sheeting, etc.

The inventive composition is an aqueous liquid that forms a stable electrostatic three-dimensional mesh-like network having charged carriers suspended in an orientation that balances electrostatic forces. These electrostatic interactions tend to homogeneously distribute beneficial components, for example, antimicrobial copper salts and, if used, anti-odor components such as cyclodextrins, throughout the plastic. The antimicrobial composition preferably comprises copper that through such electrostatic interactions is suspended in a lattice structure resulting in its high bioavailability, improved tensile strength and microbial control.

The composition can be used as an additive to plastic resin or combined with calcium carbonate at various concentrations to form enhanced filler, preferably in the form of pellets, having microbial control properties. When mixed with plastic as part of a molding, forming, or extruding process, the enhanced filler pellets distribute throughout the plastic imparting similar antimicrobial properties.

### EXAMPLES

### Example 1

### Preparation of the Composition

Sulfuric acid of about 98% purity was placed in a container at a concentration of about 32%. Distilled water was placed in a separate container and heated to 120° F., at which time ammonium sulfate was added to a concentration of about 68%. The sulfuric acid and ammonium sulfate solutions were simultaneously injected into a large (400 gal) stainless steel vessel that was maintained at 15 psi above atmospheric pressure and mechanically agitated. The reaction is exothermic and generates heat. At the interface between the acid and ammonium sulfate, the temperature is estimated at between 800 and 1200° F. The temperature of the solution as a whole has been measured at between 250 and 375° F.

A DC current of about 1-3 amps was applied about 1 foot above the bottom of the container for about 1 hour while the mixture cooled to room temperature. When the mixture reached room temperature, an additional 10 percent of the original ammonium sulfate solution was added to the cooled mixture as a stabilizer to remove free radicals.

A stock composition was prepared by combining 4.0 mL of the stabilized sulfuric acid plus ammonium sulfate solution, 3.0 g of silver sulfate, and 3.0 mL of a 2% solution of copper sulfate in stabilized sulfuric acid plus ammonium sulfate solution with 1.0 L of water. The pH of the stock solution was between about 2.5 to 3.5. The stock solution was diluted with pH amended distilled (deionized) water prior to use to achieve final pH between about 5.0 and 6.0.

### Example 2

### Preparation of Treated Filler

Enhanced filler pellets were prepared by mixing powdered calcium carbonate with the composition of Example 1 under steam in a mill blender and heating the mixture at 375° F. for 1 to 5 minutes to form a dough. The composition was added at the concentrations shown in Table 1. The dough was extruded into cool water and cut into pellets. The enhanced filler pellets were combined with polyethylene polymers and this composition was used to prepare blown plastic sheeting according to standard industry procedures.

### Example 3

### Antimicrobial Effect of Treated Filler on Blown Plastic Sheeting

The plastic sheeting containing the treated filler was cut into rectangular strips of about 3 cm×10 cm. Each strip was placed on an agar-coated, 10 cm diameter Petri plate infused with 8.4×10⁶ Bacillus sp. The plates were incubated at 38.5° C. for 48 hour and examined for bacterial growth. Results are described in Table 1. Antibacterial effects were defined as loss of bacterial growth over a particular area, as evidenced by clear areas in the bacterial lawn. Antibacterial effects were observed under the strips at concentrations of antimicrobial composition as low as 0.075% in enhanced filler. At the highest level of antimicrobial composition tested, 0.15% in enhanced filler, the antibacterial effect extended into the bacterial lawn beyond areas in direct contact with the plastic strip. These results demonstrate that the use of antimicrobial pellets as fillers in plastics imparts antimicrobial properties to the plastic product.

TABLE 1
Effect of antimicrobial in plastic on microbial growth

| Antimicrobial in filler | Visual clear zone (mm) in |
|---|---|
| (%) | bacterial lawn |
| 0 | None |
| 0.05 | None |
| 0.075 | Patches under strip |
| 0.10 | Under entire strip |
| 0.15 | Under entire strip and 1.0-1.5 mm |
| | beyond strip |

### Example 4

### Preparation of Treated Filler—Master Batch Method

Batches of linear low-density polyethylene (LLDPE) were prepared by mixing heating polyethylene resin, powdered calcium carbonate and the aqueous composition of Example 1. The composition and calcium carbonate were added at the concentrations described in Example 5. This mixture was used to prepare LLDPE plastic bars for testing according to Example 5.

### Example 5

### Improved Physical Properties of Plastic Bars Comprising Filler and the Composition

Linear low-density polyethylene (LLDPE) samples made by the master batch method of Example 3 were tested for tensile strength at the yield point, tensile elongation at the breaking point, and Young's modulus under ASTM D 638-10, conditioned and tested at 23±2° C. and 50±10% relative humidity. Quintuple replicates of LLDPE containing 0, 20%, 30%, or 40% calcium carbonate in a matrix with 0 ppm, 1500 ppm, 2000 ppm or 2500 ppm of the composition were tested. LLDPE was formed into Type I tensile bars of having dimensions of approximately 0.5 inches by 0.13 inches by 2 inches measured to the nearest 1/10,000^{th} of an inch. In addition, specific gravity and density of each bar were measured. Mean results of testing of the five replicates for each testing procedure are shown in Tables 2 through 6 and FIGS.: 1-6, below.

TABLE 2
Tensile Strength (psi) ± std. dev.

| | | Composition (ppm) | | | |
|---|---|---|---|---|---|
| | | 0 | 1500 | 2000 | 2500 |
| CaCO₃ | 0% | 1770 ± 11 | | | |
| (%) | 20% | 1750 ± 11 | 1760 ± 8.4 | 1780 ± 13 | 1870 ± 15 |
| | 30% | 1790 ± 8.9 | 1820 ± 21 | 1840 ± 5.5 | 1900 ± 11 |
| | 40% | 1810 ± 31 | 1860 ± 17 | 1870 ± 8.9 | 1890 ± 8.9 |

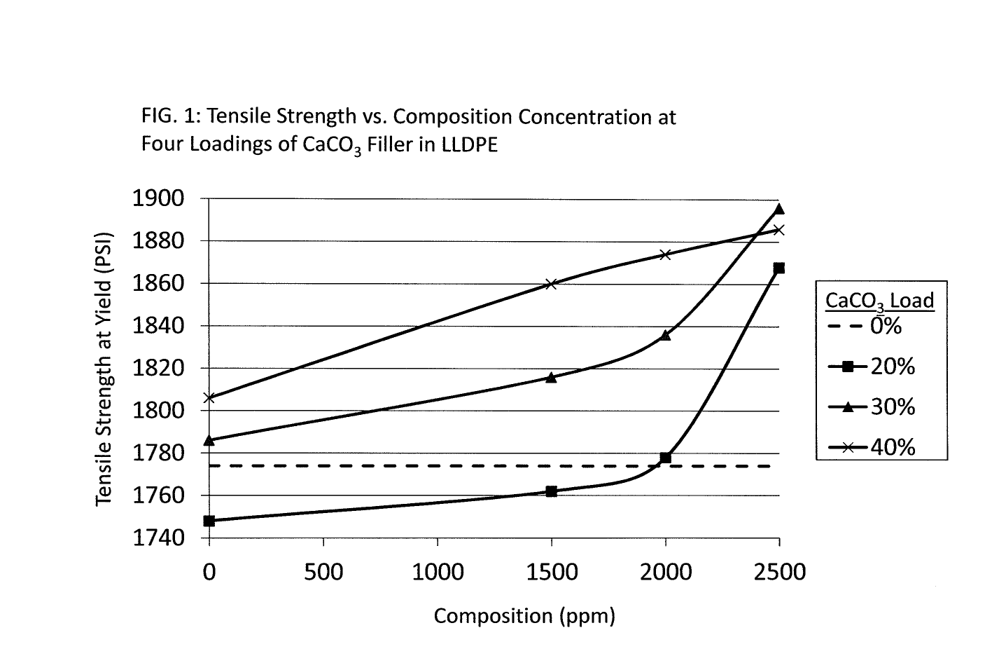

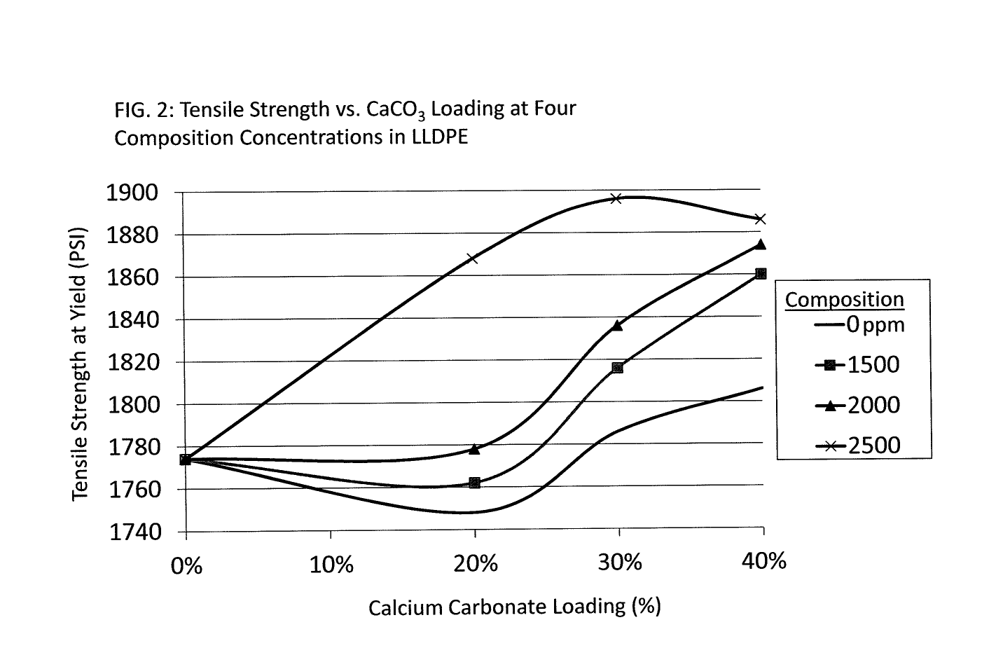

As shown in Table 2 and FIGS. 1-2, tensile strength increases with calcium carbonate concentration. Surprisingly, however, tensile strength is enhanced with the addition of the composition to LLDPE containing calcium carbonate, indicating that the composition enhances the strength-imparting properties of calcium carbonate-quite dramatically in the 20% calcium carbonate sample-at least up to a point at which tensile strength might reach a maximum.

TABLE 3
Tensile Elongation (%) ± std. dev

| | | Composition (ppm) | | | |
|---|---|---|---|---|---|
| | | 0 | 1500 | 2000 | 2500 |
| CaCO₃ (%) | 0% | 560 ± 26 | | | |
| | 20% | 480 ± 140 | 170 ± 34 | 320 ± 97 | 290 ± 130 |
| | 30% | 60 ± 19 | 55 ± 14 | 140 ± 47 | 40 ± 1.5 |
| | 40% | 22 ± 2.9 | 25 ± 3.8 | 16 ± 1 | 22 ± 2.6 |

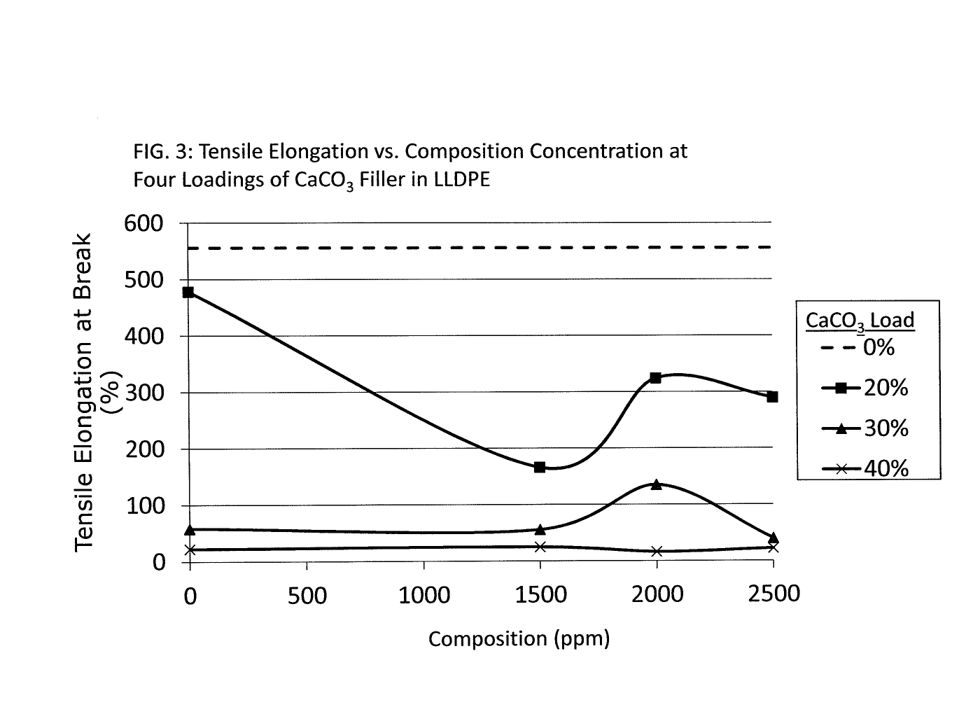

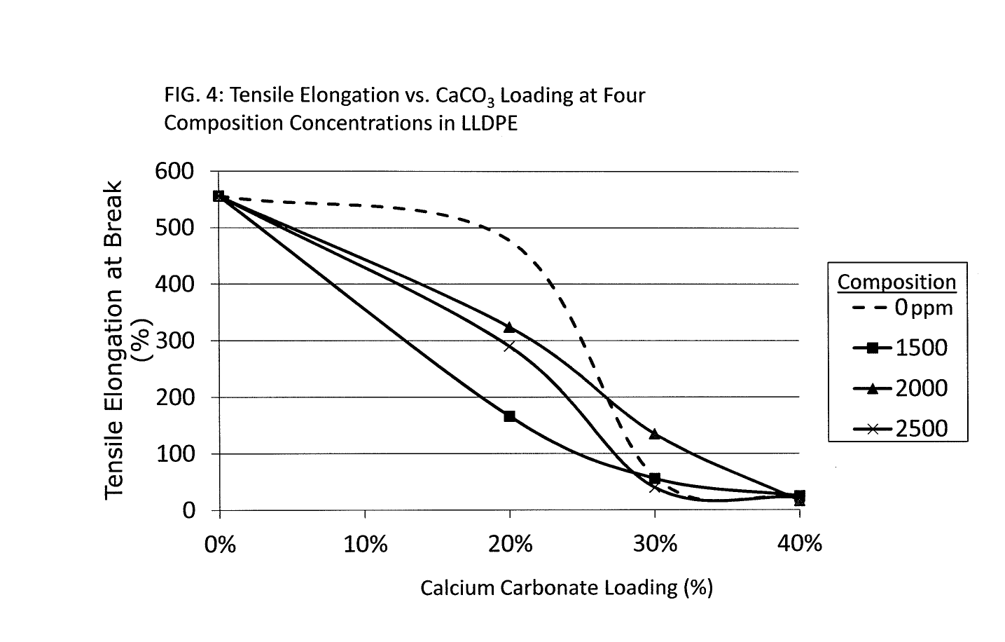

The composition generally decreases the tensile elongation of LLDPE in relation to calcium carbonate concentration. Surprisingly, while the data in Table 3 and FIGS. 3-4 indicate that at about 20% calcium carbonate without addition of the composition, the tensile elongation decreases precipitously. Addition of the composition appears to moderate this effect, rendering the decrease in tensile elongation in relation to calcium carbonate concentration more linear.

TABLE 4
Young's Modulus (ksi) ± std. dev

| | | Composition (ppm) | | | |
|---|---|---|---|---|---|
| | | 0 | 1500 | 2000 | 2500 |
| CaCO₃ (%) | 0% | 60.5 ± 1.4 | | | |
| | 20% | 79.0 ± 1.3 | 79.3 ± 3.3 | 77.4 ± 1.6 | 85.8 ± 2.8 |
| | 30% | 93.9 ± 2.5 | 87.7 ± 2.0 | 86.2 ± .83 | 97.7 ± 1.3 |
| | 40% | 104 ± 5.2 | 112 ± 3.8 | 122 ± 3.6 | 110 ± 2.9 |

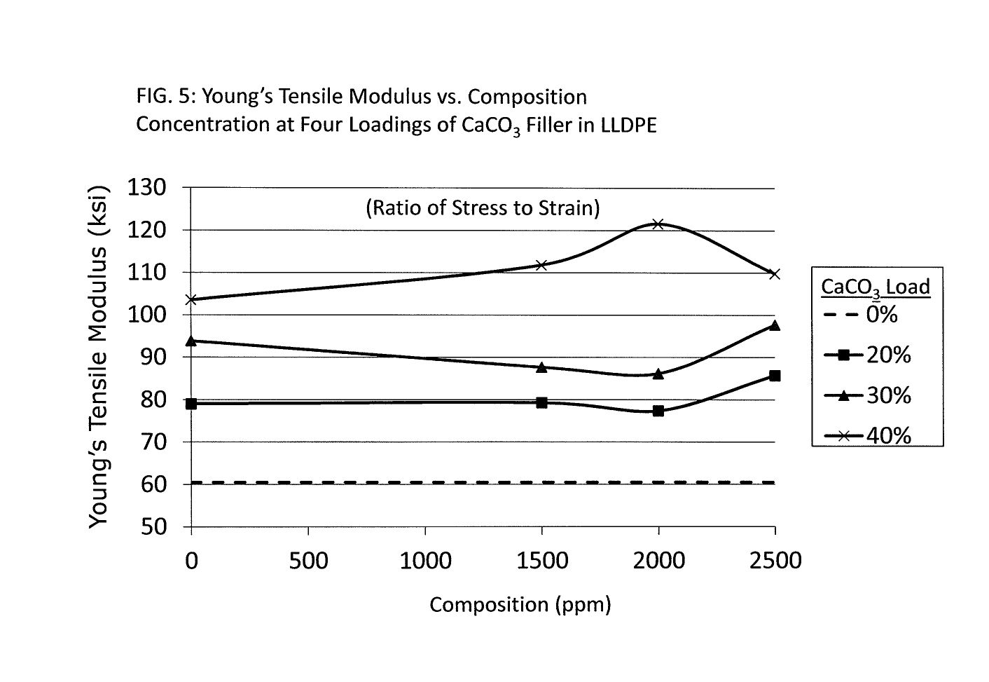

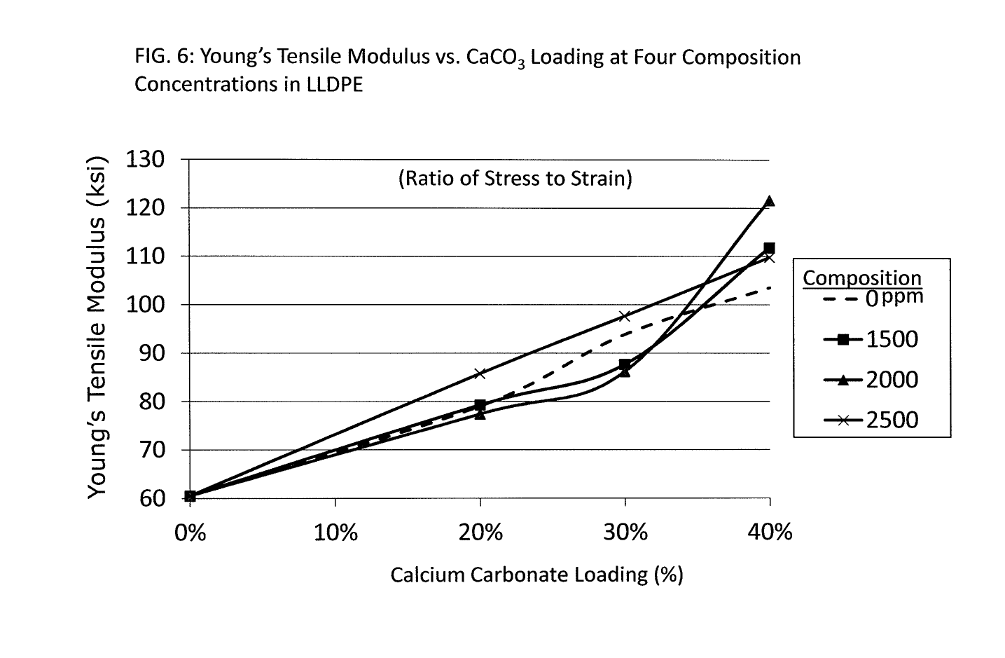

Generally speaking, Young's modulus is a measurement of stiffness of an elastic material, and is useful in characterizing plastics. The data presented in Table 4 and FIGS. 5-6 indicate that the inventive composition increases the rigidity of LLDPE over the addition of calcium carbonate alone. The ability to increase rigidity has implications for efficient manufacturing, in terms both of quicker cure time for plastics during manufacturing and of the ability to more cost-effectively manufacture rigid plastics.

TABLE 5
Specific Gravity (23/23° C.)

Composition (ppm)

| | | 0 | 1500 | 2000 | 2500 |
|---|---|---|---|---|---|
| CaCO₃ (%) | 0% | 0.930 | | | |
| | 20% | 1.07 | 1.10 | 1.08 | 1.08 |
| | 30% | 1.16 | 1.16 | 1.13 | 1.18 |
| | 40% | 1.25 | 1.25 | 1.28 | 1.25 |

TABLE 6
Density (g/cm³)

Composition (ppm)

| | | 0 | 1500 | 2000 | 2500 |
|---|---|---|---|---|---|
| CaCO₃ (%) | 0% | 0.927 | | | |
| | 20% | 1.07 | 1.10 | 1.08 | 1.07 |
| | 30% | 1.16 | 1.15 | 1.13 | 1.18 |
| | 40% | 1.24 | 1.25 | 1.28 | 1.25 |

Tables 5 and 6 confirm that while calcium carbonate increases both density and specific gravity of the LLDPE bars, addition of the inventive composition has negligible effect on these parameters.

From the data presented in Tables 2-6 and other tests, it was concluded that within the useful range, as the amount of added calcium carbonate increases, the tensile strength of the plastic increases. Normally, when calcium carbonate reaches about 15% of the plastic mixture, however, strength begins to decrease due to point defects in the plastic. Cracking in the plastic is believed to be due to uneven distribution of calcium carbonate. The present inventive composition causes calcium carbonate to disperse more homogenously throughout the plastic, perhaps due to decreased size of calcium carbonate aggregates, electrostatic dispersion and to intermolecular crosslinking leading to increased tensile strength and rigidity of the plastic and, as is shown in Table 3, decreased tensile elongation. Because calcium carbonate is more evenly dispersed when combined with the composition, point defects and cracking are reduced.

An optimum mixture of calcium carbonate and the present composition renders it possible to increase plastic strength to a greater degree than is achievable by calcium carbonate alone. Indeed, stronger plastics can now be achieved by replacing some of the hydrocarbon-based monomer with less-expensive enhanced filler, resulting in lower total plastic cost in relation to strength or, in the case of foamed plastics, such as, for example, polyurethane foam, cost in relation to volume. Lowering the ratio of polymer to filler without sacrificing strength would lower plastic costs and require less petroleum resources.

### Example 6

### Examples of Products That Could Benefit From the Enhanced Filler

For at least the reasons noted above, examples of plastic products that could be improved by incorporating the instant enhanced filler include, but are not limited to, the following:

Quick service restaurant (QSR) serving trays incorporating the enhanced filler of the present application could benefit from improved microbial control, a less flexible and more rigid structure less likely to bend or break, estimated two-times longer service life, and faster setting time and lower material cost during manufacturing.

By incorporating the enhanced filler into plastic cutlery comprising polystyrene or polypropylene materials, the industry could benefit from the enhanced microbial control, improved and persistent strength and rigidity, and lower material cost due in relation to performance due to increased ratio of calcium carbonate to plastic.

Dental “saliva” tubing could be improved by incorporating the enhanced filler to enhance microbial control, increase resistance to cracking, reduce manufacturing waste by an estimated 75%, reduce manufacturing time attributable to faster setting time and lower material cost.

We claim:

1. A method for preparing an inorganic filler for use in the synthesis of a plastic and improving properties of the plastic selected from the group consisting of increasing antimicrobial properties, increasing tensile strength, decreasing tensile elongation, increasing rigidity, increasing impact resistance and increasing brittleness of the plastic comprising the steps of
(a) blending an inorganic filler material with an aqueous composition comprising sodium sulfate or ammonium sulfate, silver sulfate, copper to sulfate, and sulfuric acid; and
(b) forming the blended mixture into a shape and size suitable for the particular use of the filler.

2. The method of claim 1, wherein the inorganic filler is selected from the group consisting of calcium carbonate, talc, magnesium carbonate, synthetic carbonates, wollastonite, dolomite, gypsum, kaolinite, aluminum hydroxide, aluminosilicates, mica, natural siliconates, silica containing aggregates, zeolites and mixtures thereof.

3. The method of claim 2 wherein the concentration of sodium sulfate or ammonium sulfate is 3-4% weight to weight, the concentration of the silver sulfate is 0.2-0.4% weight to weight, the concentration of the copper sulfate is 0.1-1% weight to weight, and the concentration of the sulfuric acid is 10-15% weight to weight.

4. The method of claim 1, wherein the blended mixture is formed into pellets, spheres, particles, flakes, fibers, beads, thermoplastic or thermosetting plastics.

5. The method of claim 2, wherein the inorganic filler is calcium carbonate.

6. An antimicrobial filler for plastics prepared by the method of claim 1.

7. A plastic comprising a filler prepared by the method of claim 1, wherein the plastic has properties selected from the group consisting of antimicrobial properties, increased tensile strength, decreased tensile elongation, increased impact resistance, reduced brittleness and increased rigidity as measured by Young's modulus compared to filler prepared by another method.

8. The plastic of claim 7, wherein the plastic is selected from the group consisting of polypropylene, polyester, polystyrene, polyethylene, polyvinyl chloride, polytetrafluoroethylene, and mixtures thereof.

9. A plastic product comprising a filler prepared by the method of claim 1, wherein the plastic product has properties selected from the group consisting of antimicrobial properties, increased tensile strength, decreased tensile elongation, increased impact resistance, reduced brittleness and increased rigidity as measured by Young's modulus compared to a plastic product comprising filler prepared by another method.

10. The plastic product of claim 9, wherein the plastic product is an injection molded, extruded, thermoformed or blown plastic product.

11. The plastic product of claim 9, wherein tensile elongation is increased when calcium carbonate loading is at least 30% by weight.

12. An enhanced filler for use in the synthesis of a plastic,
wherein the enhanced filler enhances properties in the plastic selected from the group consisting of antimicrobial properties, increased tensile strength, decreased tensile elongation, increased impact resistance, reduced brittleness and increased rigidity as measured by Young's modulus compared to filler that is not enhanced,
and wherein the enhanced filler comprises an inorganic filler material;
an aqueous composition comprising metal salts selected from the group consisting of sodium sulfate or ammonium sulfate, silver sulfate, copper sulfate, and sulfuric acid.

13. The enhanced filler of claim 12, wherein the inorganic filler material is selected from the group consisting of calcium carbonate, talc, magnesium carbonate, synthetic carbonates, wollastonite, dolomite, gypsum, kaolinite, aluminum hydroxide, aluminosilicates, mica, natural siliconates, silica containing aggregates, zeolites and mixtures thereof.

14. A method for preparing an inorganic filler for use in the synthesis of a plastic and increasing the odor removal properties of the plastic comprising the steps of
(a) blending an inorganic filler material with an aqueous composition comprising sodium sulfate or ammonium sulfate, silver sulfate, copper sulfate, a cyclodextrin and sulfuric acid; and
(b) forming the blended mixture into a shape and size suitable for the particular use of the filler.

15. The method of claim 14, wherein the cyclodextrin is alpha or gamma cyclodextrin.

16. The method of claim 14, wherein the cyclodextrin is beta cyclodextrin.

17. A method for improving a physical property of a plastic selected from the group consisting of antimicrobial properties, increased tensile strength, decreased tensile elongation, increased impact resistance, reduced brittleness and increased rigidity as measured by Young's modulus, the method comprising the step of mixing an inorganic filler material; an aqueous composition comprising sodium sulfate or ammonium sulfate, silver sulfate, copper sulfate, and sulfuric acid; and a plastic resin.

18. The method of claim 17, wherein the inorganic filler is selected from the group consisting of calcium carbonate, talc, magnesium carbonate, synthetic carbonates, wollastonite, dolomite, gypsum, kaolinite, aluminum hydroxide, aluminosilicates, mica, natural siliconates, silica containing aggregates, zeolites and mixtures thereof.

19. The method of claim 17 wherein the concentration of sodium sulfate or ammonium sulfate is 3-4% weight to weight, the concentration of the silver sulfate is 0.2-0.4% weight to weight, the concentration of the copper sulfate is 0.1-1% weight to weight, and the concentration of the sulfuric acid is 10-15% weight to weight.

20. The method of claim 17 wherein the plastic resin is added to the mixed inorganic filler material and aqueous composition after the mixture is formed into a shape and size suitable for use with the plastic resin.
